(19) United States
(12) Patent Application Publication
(10) Pub. No.: US 2022/0289050 A1
(43) Pub. Date: Sep. 15, 2022

(54) Automated System of Charging an Electric Vehicle

(71) Applicants: Samuel Norman Neff, Novato, CA (US); Drake Gotham Johnson, San Francisco, CA (US); Michael Tony Dennison, Corte Madera, CA (US)

(72) Inventors: Samuel Norman Neff, Novato, CA (US); Drake Gotham Johnson, San Francisco, CA (US); Michael Tony Dennison, Corte Madera, CA (US)

(21) Appl. No.: 17/695,813

(22) Filed: Mar. 15, 2022

Related U.S. Application Data
(60) Provisional application No. 63/161,430, filed on Mar. 15, 2021.

(51) Int. Cl. B60L 53/16; B60L 53/30; B60L 53/35; B60L 53/66; B60L 53/31

(52) U.S. Cl. CPC B60L 53/16; B60L 53/305; B60L 53/35; B60L 53/66; B60L 53/31

(57) ABSTRACT

An automated system of charging an electric vehicle (EV) provides a means of adapting any given EV or hybrid-electric vehicle for use with an automated recharging network. An adapter body with a contact plate and a port connector is positioned between the EV and any external power source to electrically connect between said external power source and the existing charging receptacle of the host EV. At least one guidance beacon is mounted to the adapter body and is used to guide the engagement of any external charging equipment onto the contact plate to establish a means of recharging the internal batteries of the EV.

The current application claims a priority to the U.S. Provisional Patent application Ser. No. 63/161,430 filed on Mar. 15, 2021.

### FIELD OF THE INVENTION

The present invention generally relates to the field of electric vehicles and related support systems. More specifically, the present invention recites a novel automated vehicle charging station and an interconnection module intended to interact with said charging station.

### BACKGROUND OF THE INVENTION

Electric vehicles (EVs) have emerged as a viable alternative to internal combustion vehicles in the consumer market, indicating a potential for further growth into the broader consumer market. However, current battery technology still falls short of the energy density of petroleum-based fuels. This frequently results in a ‘range anxiety’, wherein drivers are constantly concerned with running out of power while out of range of any supporting infrastructure. Accordingly, automotive manufacturers and utility companies have begun to establish a distributed network of charging stations across the country, enabling an EV driver to plot a course between charger stations for long trips. While this is notionally similar to gas stations for conventional vehicles, the recharging stations may vary in compatibility; some chargers only engage with certain vehicles of port-types.

To overcome these challenges, it is herein proposed that a universal adapter system operating in conjunction with a self-guided charger station may offer an improvement to extant charging systems. The universality of the adapter itself eliminates the necessity for every vehicle to conform to a single plug architecture, while simultaneously accounting for existing plug types as a benefit of the flexible design. Likewise, the associated automatic charging stations simplifies and expedites any charging stop by engaging directly to the adapter unit once the vehicle is within range of the charging station.

Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

FIG. 1 is a top-front-left perspective view of a simplified embodiment of an adapter body and associated components.

FIG. 2 is a bottom-rear-right perspective view thereof.

FIG. 3 is a left-side elevational view thereof.

FIG. 4 is a front elevational view of an exemplary use and installation of the present invention.

FIG. 5 is a detail view taken about circle 5 in FIG. 4.

FIG. 6 is a top-rear-left perspective view of the exemplary use and installation.

FIG. 7 is a top-front-left view thereof, wherein multiple instances of the present invention are shown equipped in series to multiple parking spaces.

FIG. 8 is a left-side elevational view of an alternate embodiment of the adapter body and associated components.

FIG. 9 is a top-front-left perspective view thereof.

FIG. 10 is a perspective schematic view of the adapter body and associated components engaged to an elongated contact head in a first electrical configuration.

FIG. 11 is a perspective schematic view of the adapter body and associated components engaged to an elongated contact head in a second electrical configuration.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

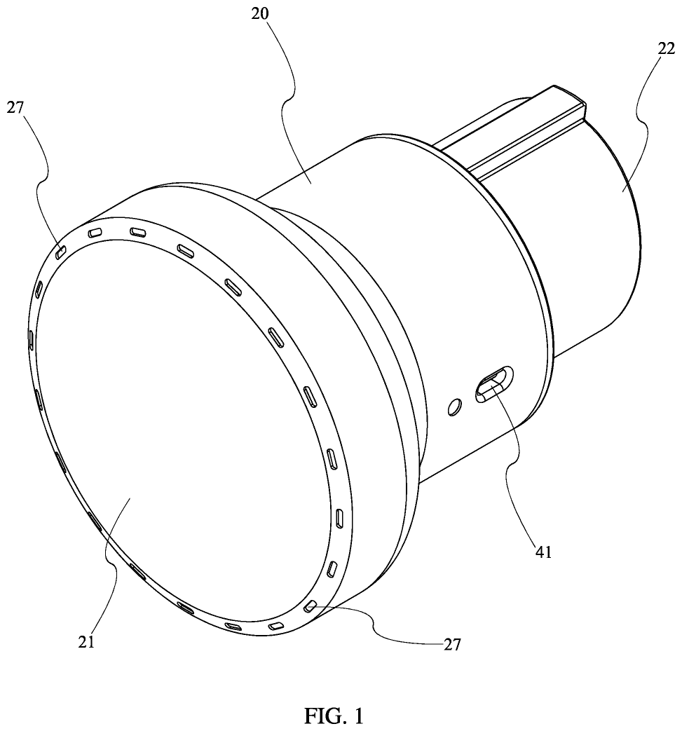

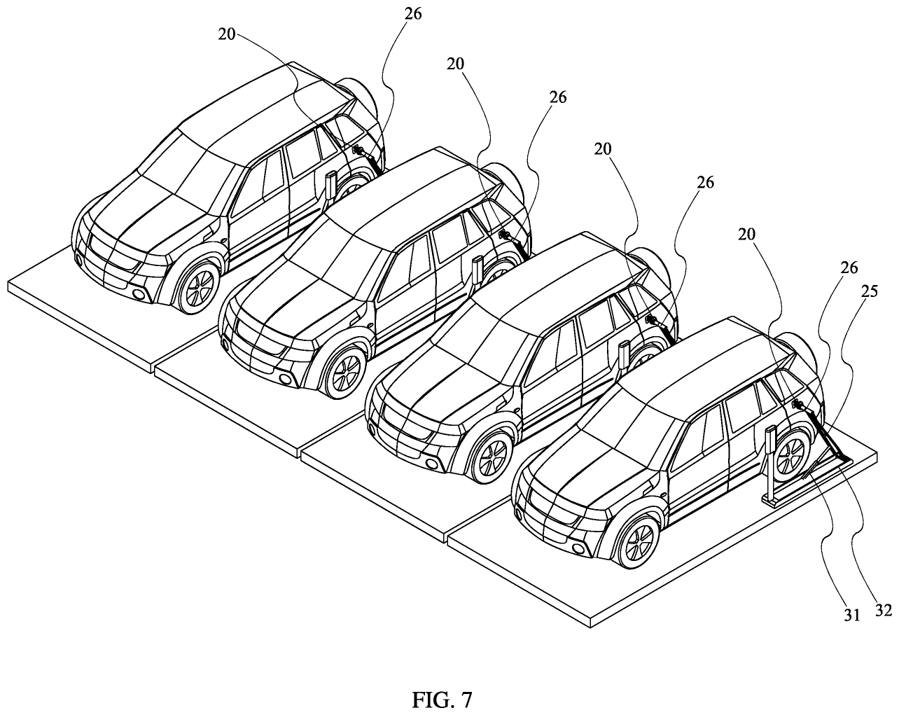

In reference to FIG. 1 through 11, the present invention is an automated system of charging an electric vehicle (EV) employed as a universal adapter system between any plug-in rechargeable vehicle, including hybridized vehicles of all types and varieties. Accordingly, the specific descriptors and form-factors for any industry standard connectors, supporting equipment, or other conventional components may vary across to use-cases and embodiments without departing from the original spirit and scope of the present invention.

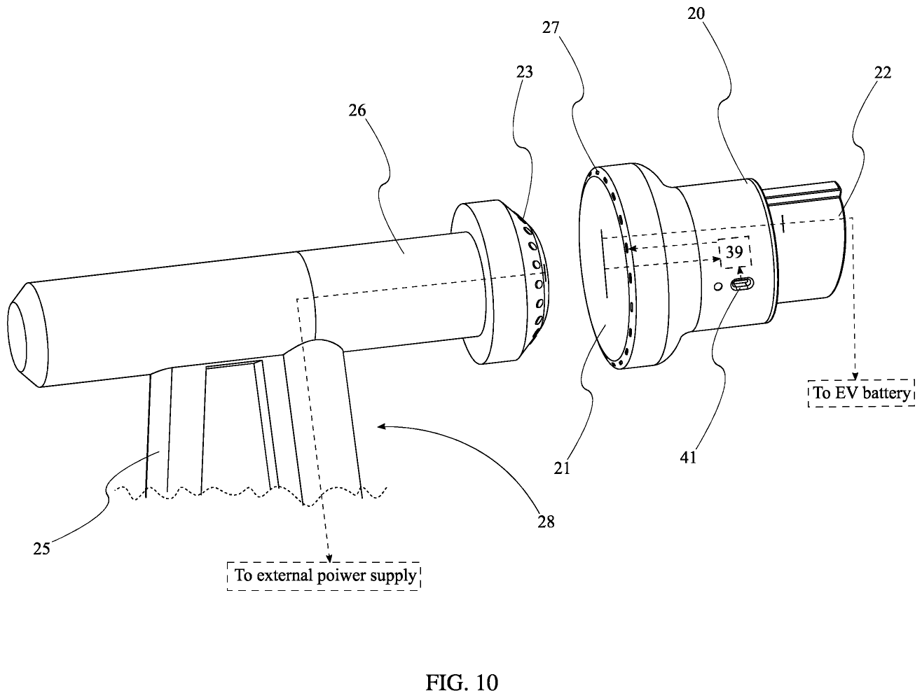

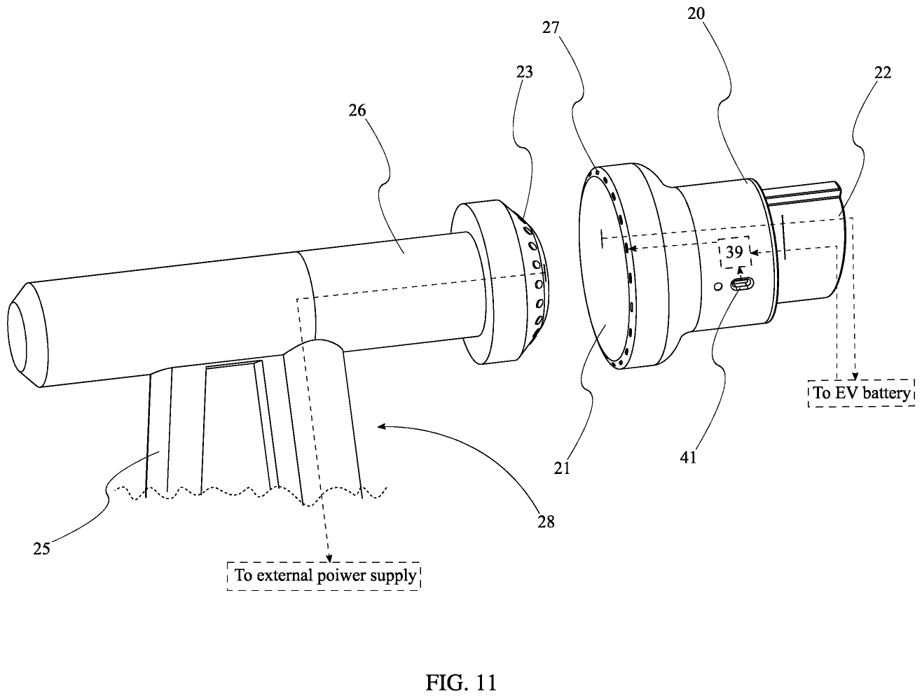

The automated system of charging an EV comprises an adapter body 20, a contact plate 21, a port connector 22, and at least one guidance beacon 23 as indicated in FIG. 1 through 3. The adapter body 20 constitutes a rigid structural shell suitable for containing, supporting, and protecting the sensitive elements of the present invention across all embodiments. The contact plate 21 is terminally mounted to the adapter body 20, ideally positioned to face outwards and away from the host-EV and towards any compatible roadside charging infrastructure. The port connector 22 is terminally mounted to the adapter body 20, opposite the contact plate 21, connected to the charging receptacle of the host-EV. The at least one guidance beacon 23 is laterally mounted to the adapter body 20, adjacent to the contact plate 21. The at least one guidance beacon 23 provides a machine-readable or otherwise remotely detectable element for an automated charging mechanism to locate and intercept the contact plate 21, thereby enabling the automatic charging of the onboard batteries of a host-EV. Accordingly, the contact plate 21 and the at least one guidance beacon 23 are electrically connected to the port connector 22 in various configurations as illustrated in FIGS. 10 and 11.

The contact plate 21 refers to a universal electrical receptor element suitable for conducting electrical current suitable for recharging the traction battery of any host-EV. The open format of the contact plate 21 obviates the need for precise alignment of the contact plate 21 and any external charging apparatus by introducing a large margin-of-error. More specifically, the contact plate 21 is intentionally oversized to permit minor misalignment of equipment while still maintaining an operable electrical connection suitable for conducting a recharge cycle of the EV batteries.

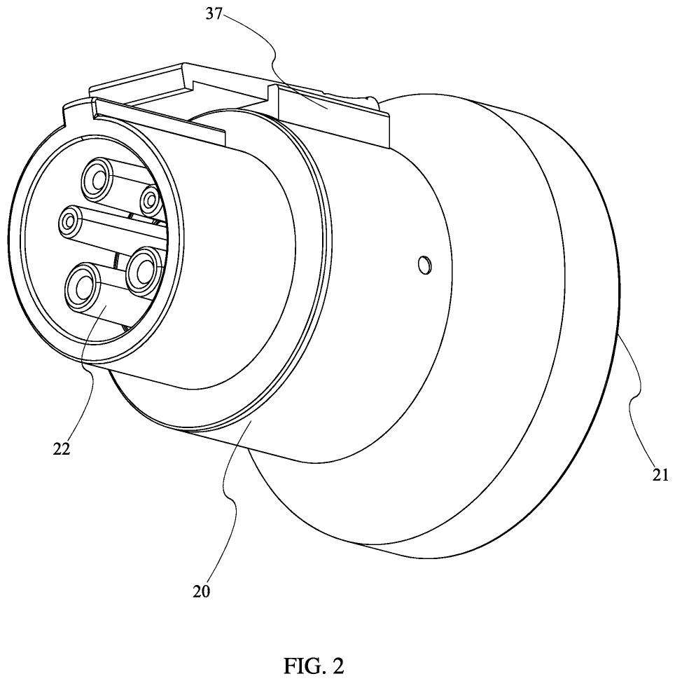

The port connector 22 broadly encompasses any electrical interconnector or plug-structure suitable to engage directly to the existing charging receptacle of an EV. As illustrated in FIG. 2, the exemplary embodiment of the port connector 22 is shown as a conventional SAE J1772 connector, or ‘J-plug’. This connector may be replaced or supplemented with any other vehicle power connector, both as a permanent fixture from the point of manufacture, or as a modular interstitial attachment between the contact plate 21 and the EV itself. Likewise, portions of the adapter body 20 may be standardized to enable the modular exchange of various embodiments of the contact plate 21 and the port connector 22.

In one configuration, the at least one guidance beacon 23 is provided with operating power from the EV through the port connector 22 to facilitate engagement with any external source of power. Further, the connection between the contact plate 21 and the port connector 22 enables the transfer of electrical power from any external power source, through the contact plate 21, to the port connector 22, then into the onboard battery of the EV. This configuration enables the continuous operation of the at least one guidance system using the EV battery, provided that the operator does not completely expend the EV battery during normal use.

In a first embodiment, the at least one guidance beacon 23 constitutes an active-guidance component; generally extending across the full range of conventional powered guidance systems characterized by the programmable interaction of the at least one guidance beacon 23 and any external sensor package. In another embodiment, the at least one guidance beacon 23 may define a static, unpowered indicia or other identifiable marking suitable for detection by said external sensor array. Examples of these embodiments include, for example, scannable bar-code or quick response (QR) sticker. These alternate embodiments may also include passive radio-frequency identification (RFID) tags that produce a detectable signal when exposed to a local inductive current. In this embodiment, the electrical connection to the at least one guidance beacon 23 is secondary to the guidance functions enabled by the presence of any passively identifiable item. In various modes and use-cases, the at least one guidance beacon 23 may be backlit or otherwise illuminated to aid in visual acquisition during night hours or in inclement weather conditions. Further, the at least one guidance beacon 23 may be integrated as part of a contact-confirmation system, i.e., a completed external circuit between the at least one guidance beacon 23 and the contact plate 21 must be completed before charging functions are enabled.

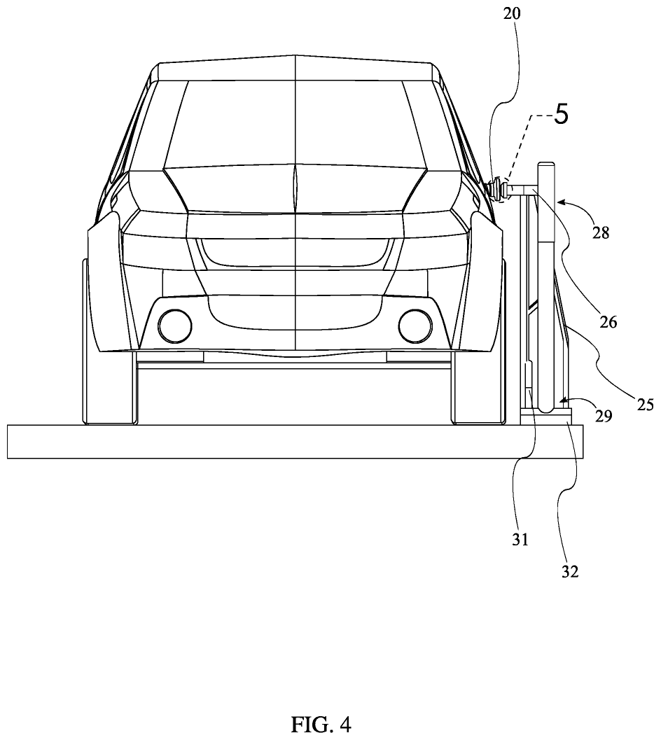

As illustrated in FIG. 4 through 7, the present invention further comprises at least one articulated charging arm 25, an elongated contact head 26, and at least one alignment sensor 27 as portions of any curbside or stationary charging infrastructure configured to operate in conjunction with the adapter-assembly described above. In general, the at least one articulated charging arm 25 constitutes any self-motivated gantry configured to position the elongated contact head 26 into proximity with the contact plate 21. Accordingly, the elongated contact head 26 defines a means of creating a conductive path between the contact plate 21 and any external power supply suitable for charging the EV batteries. The at least one alignment sensor 27 is configured and positioned to operate in conjunction with the at least one guidance beacon 23, enabling the autonomous positioning of the elongated contact head 26 onto the contact plate 21.

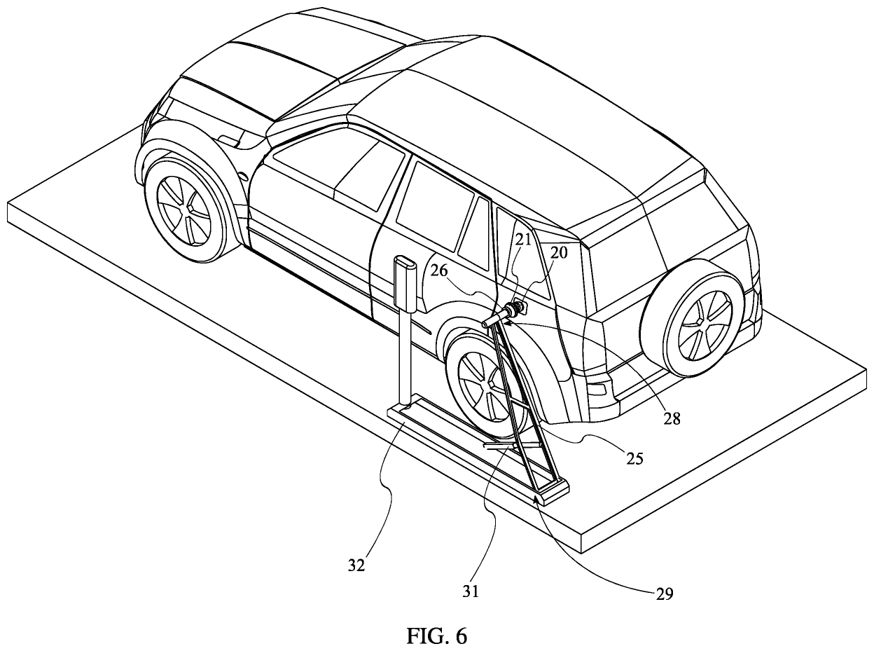

More specifically, the at least one articulated charging arm 25 comprises a free arm end 28 and a fixed arm end 29 as indicated in FIG. 6. The free arm end 28 refers to the mobile segment of the at least one articulated charging arm 25 in general, also referred to as an end-effector in other contexts regarding robotic constructs. The fixed arm end 29 broadly refers to any permanent mounting between the at least one articulated charging arm 25 and any element of a roadside charging station (e.g., curbside, wall, parking stall, elevator, etc.).

The fixed arm end 29 is positioned offset from the adapter body 20 such that the at least one articulated charging arm 25 is retractable out of the path of the EV. The elongated contact head 26 is mounted onto the free arm end 28, wherein the at least one articulated charging arm 25 is configured to position the elongated contact head 26 proximal to the contact plate 21, i.e., gross alignment. The at least one alignment sensor 27 is mounted onto the elongated contact head 26 to enable fine alignment and final contact between the elongated contact head 26 and the contact plate 21. More specifically, the at least one alignment sensor 27 is oriented towards the contact plate 21 such that the at least one alignment sensor 27 detects the position of the adapter body 20 and the contact plate 21 by positional inference. Across a variety of potential embodiments, the at least one guidance beacon 23 produces any type of detectable signal that might be received by the at least one alignment sensor 27 to indicate a relative range and direction. Non-exhaustively, this includes the use of radio signals, infrared light, magnetic field detectors, visible illumination, ultrasonic pulses, or any other form of discrete short-range communications systems in various alternate embodiments. Further, any and all of these signal categories may be employed in combination or individually without departing from the original spirit and scope of the present invention.

In a preferred embodiment, the at least one guidance beacon 23 is referenced via the at least one alignment sensor 27 to identify the displacement between the at least one guidance beacon 23 and the at least one alignment sensor 27. Operating based on a known offset between the at least one guidance beacon 23 and the contact plate 21, the free arm end 28 is gradually advanced into alignment with the contact plate 21. Further, the elongated contact head 26 may be advanced into physical contact with the contact plate 21 based on a final positional feedback loop between the at least one alignment sensor 27 and the at least one guidance beacon 23.

In one embodiment, the at least one alignment sensor 27 may constitute a singular high-resolution digital camera configured to detect the at least one guidance beacon 23. Detection and positive identification of the at least one guidance beacon 23 is ideally performed via software-based image discrimination within this embodiment, although intentional limitation of the camera viewing-angle may be used to enable alignment by analog means. Further, the arrangement of non-correspondent instances of the at least one alignment sensor 27 and the at least one guidance beacon 23 may be utilized in any guidance process. For example, the singular camera may be arranged opposite a multitude of placed indicia, wherein each of the placed indicia define an instance of at least one guidance beacon 23. Further, regardless of the number of instances of at least one guidance beacon 23 deployed in any embodiment, the at least one alignment sensor 27 may utilize any or all of the at least one guidance beacon 23 without departing from the original spirit and scope of the present invention.

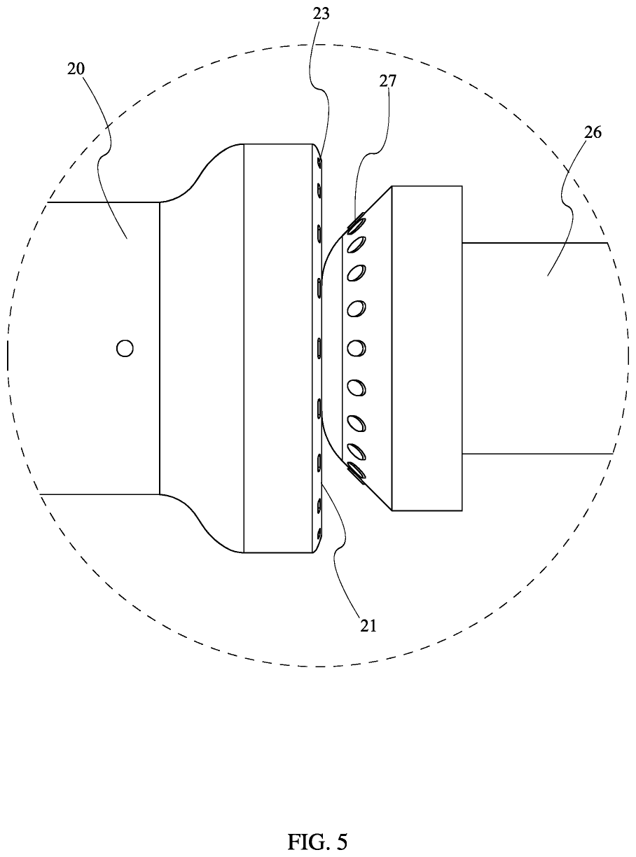

In another embodiment, the at least one guidance beacon 23 is a plurality of guidance beacons, and the at least one alignment sensor 27 is a plurality of alignment sensors as shown in FIG. 5. The plurality of guidance beacons is radially positioned around the contact plate 21, and each of the plurality of alignment sensors is aligned to a corresponding beacon from the plurality of guidance beacons. It is proposed that the reliability and accuracy of the alignment process outlined above may be improved by increasing the volume of fixed reference pairs in the feedback loop, i.e., the plurality of guidance beacons and the plurality of alignment sensors may be used as redundant elements to ensure at least one effective pairing is useable for guidance. The alignment process may also be refined via a consensus-based correction loop, wherein the corresponding pairs are continuously polled for status to determine whether a corrective move is bringing the elongated contact head 26 into or out of alignment with the contact plate 21.

In a further embodiment, the plurality of guidance beacons is a plurality of light emitters, and the plurality of alignment sensors is a plurality of photoreceptors. Each of the plurality of light emitters is in optical communication with a corresponding photoreceptor from the plurality of photoreceptors as illustrated in FIGS. 10 and 11. The pattern, color, and intensity of the light produced by the plurality of light emitters are detected by the plurality of photoreceptors to provide guidance for the at least one articulated charging arm 25. Corrections may be determined by the percentage of light received by each of the plurality of photoreceptors, wherein the at least one articulated charging arm 25 is configured to advance along a given vector until the volume of received light begins to diminish before starting along another randomized vector until full-light intensity is achieved. Further, the plurality of photoreceptors may be configured to positionally seize the at least one articulated charging arm 25 in response to a received color-coded light signal, e.g., ‘green’ signaling alignment.

Utilizing visible light as a communications medium fulfills the needs for a machine-readable signal, while simultaneously being discernable by the user, i.e., the visible lights (by pattern, color, and intensity) may also indicate the status of a connection to a casual observer at a glance. For example, the at least one guidance beacon 23 may illuminate red to indicate ‘no-connection’, which the at least one alignment sensor 27 may use as a signal to continue advancing the elongated contact head 26 towards the contact plate 21 until a green, ‘connected’ signal is detected. This type of dual-function signal may be further modified with flashing patterns or shifts in light intensity to indicate various operational states. Further still, the plurality of light emitters may be configured to emit non-visible light in addition to visible light to improve signal fidelity by minimizing the significance of ambient visible light ‘noise’ to the plurality of photoreceptors.

It is further considered that a standardized, relocatable charging station specifically configured to interact with the present invention improves the utility of the invention as a whole. In reference to FIGS. 4 and 6, the present invention further comprises a lifting actuator 31 and an arm base 32. The fixed arm end 29 is hingedly connected to the arm base 32, enabling the at least one articulated charging arm 25 to rise out of the arm base 32. More specifically, the lifting actuator 31 is operatively coupled between the arm base 32 and the at least one articulated charging arm 25, wherein the lifting actuator 31 is used to selectively offset the free arm end 28 from the arm base 32. The lifting actuator 31 constitutes any type of linear actuator suitable for precision control, ideally referring to a stepper-operated electrical linear actuator. The offset between the arm base 32 and the free arm end 28 is defined along an arc configured to reach any necessary height to prong the elongated contact head 26 into proximity of the contact head.

In reference to FIG. 5, the elongated contact head 26 is pressed against the contact plate 21 by any operative force conducted through or along the at least one articulated charging arm 25. In one embodiment, a secondary linear actuator or extensible element of the elongated contact head 26 may maneuver the elongated head into contact with the contact plate 21. The elongated contact head 26 is electrically connected to the port connector 22 through the contact plate 21 as previously outlined, wherein the elongated contact head 26 is further connected to any external power supply (e.g., stationary battery, municipal grid, renewable array, on-site generator, etc.). This electrical connection is generally supported along or through the at least one articulated charging arm 25, but the specifical arrangement of cabling may vary depending on environmental and practical factors relating to the installation of the arm base 32 (e.g., orientation relative to the roadway, operating current, source of input power, etc.).

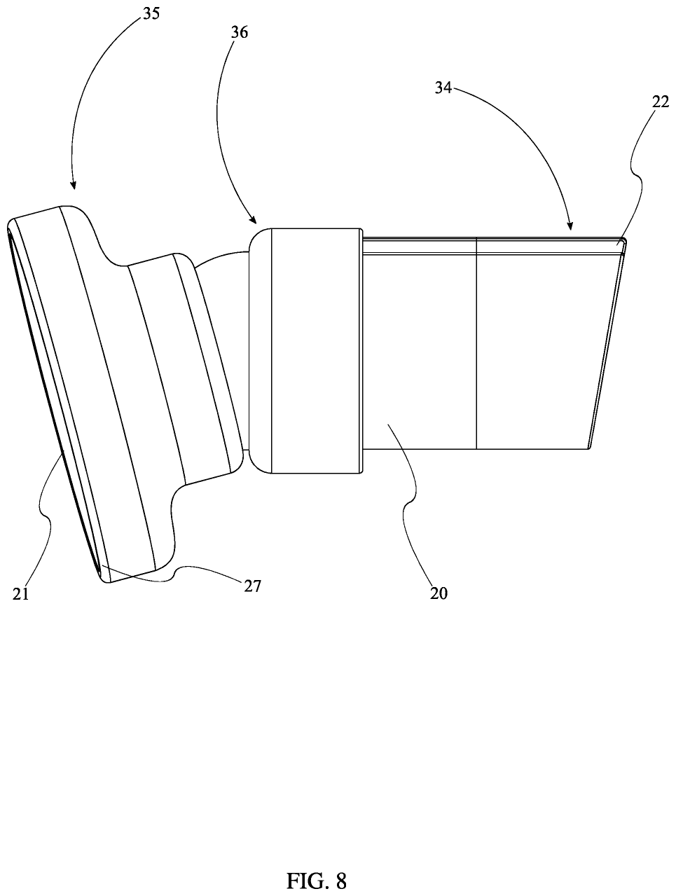

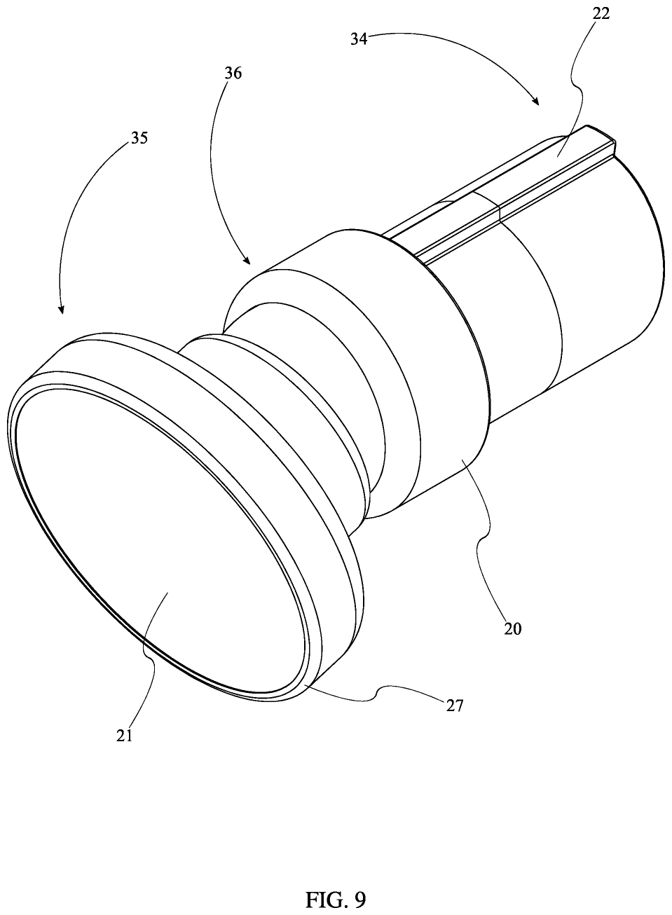

In the embodiment shown in FIGS. 8 and 9, the present invention is compatibilized for use in a variety of EVs. More specifically, the adapter body 20 is configured as a flexible element to conform and accommodate various body lines and curvature of a wider variety of vehicles than might be possible with an inflexible embodiment thereof. Accordingly, the adapter body 20 comprises a proximal portion 34, a distal portion 35, and a ball-and-socket joint 36 to allow for said flexibility. The proximal portion 34 and the distal portion 35 are pivotably connected to each other by the ball-and-socket joint 36. More specifically, the port connector 22 is integrated into the proximal portion 34, opposite the ball-and-socket joint 36. Likewise, the contact plate 21 is integrated into the distal portion 35, opposite the ball-and-socket joint 36. In this embodiment, the ball-and-socket joint 36 is used to adjustably orient the contact plate 21 relative to the port connector 22 to affect the final static orientation of the adapter body 20. This enables an operator to orient the contact plate 21 to a perpendicular relationship with the elongated contact head 26, thereby ensuring that proper contact can be made as the at least one articulated charging arm 25 advances the elongated contact head 26 into the contact plate 21.

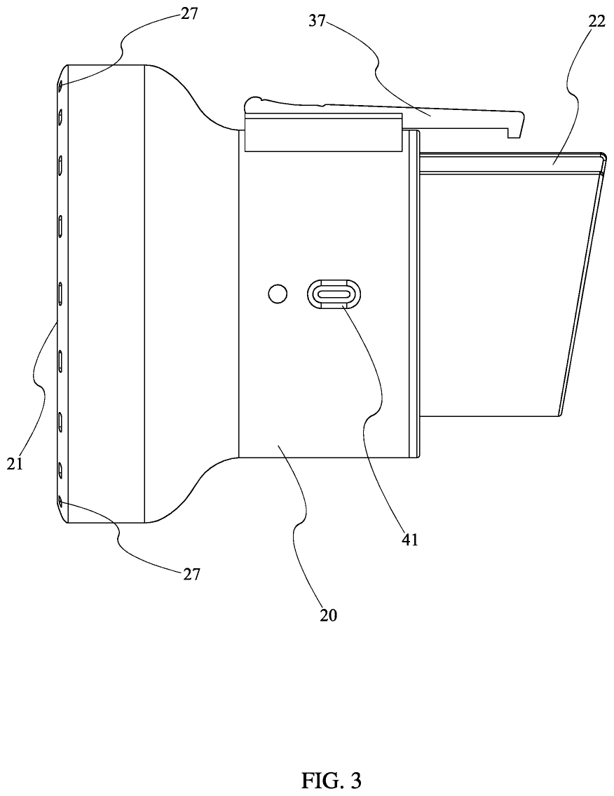

It is further considered that the host-EV may provide some means for conventional charging cables to lock into position during recharge cycles. Accordingly, the adapter body 20 may be configured to use these locking features to fix the present invention into the charging receptable in a similar fashion to a conventional charging cable. In reference to FIGS. 2 and 3 the present invention may further comprise at least one retention feature 37 laterally mounted to the adapter body 20, adjacent to the port connector 22. The at least one retention feature 37 broadly encompasses any type of releasable manual engagement that utilizes existing features of the host-EV to fix the adapter body 20 into the charging receptable. It is further considered that the at least one retention feature 37 may be configured as a semi-permanent attachment to the host-EV, wherein an operator may elect to leave the adapter body 20 in-place to permit autonomous recharging of EVs that were not conventionally equipped with such features. In this manner, the present invention serves as a standalone modification to any existing EV.

Expanding upon the embodiment of the present invention as a self-supported modification to existing EVs, the present invention may further comprise a portable power supply 39 as indicated in FIGS. 10 and 11. The portable power supply 39 is mounted within the adapter body 20 and is electrically connected to the contact plate 21 and at least one guidance beacon 23. This arrangement enables the at least one guidance beacon 23 to function independent of the EV battery, wherein the portable power supply 39 is replenished during any recharging operations performed across the contact plate 21. This configuration defines a means of separating the function of the at least one guidance beacon 23 from the EV entirely, thereby imposing no parasitic draw upon the EV battery to function.

Further, the present invention may further comprise a charging port 41 to enable the portable power supply 39 to be replenished without using a vehicle charging station. The charging port 41 is laterally integrated into the adapter body 20 and is electrically connected to the portable power supply 39 as indicated in FIG. 10. This arrangement enables the operator to restore the at least one guidance beacon 23 to functionality even if the portable power supply 39 has been completely expended, generally presumed to occur if no EV recharging is performed for extended periods. The charging port 41 is generally intended for emergency recharging of the portable power supply 39, but the charging port 41 may also be configured to output low-voltage power to recharge small personal devices in at least one configuration.

Further, the portable power supply 39 may be configured to parasitically draw power directly from the EV battery through the port connector 22 in another configuration as illustrated in FIG. 11. More specifically, the portable power supply 39 is electrically connected to port connector 22 to enable the onboard battery systems of the EV to provide any necessary operating power to the at least one guidance beacon 23 and the charging port 41. This embodiment fully integrates the functions and power-demands of the adapter body 20 into the existing electrical systems of the host-EV, obviating any need to siphon incoming current during recharging through the contact plate 21. Instead, all power initially flows into the EV battery through the port connector 22, before being redistributed to the portable power supply 39. This arrangement is not necessarily compatible with all existing EV models, but a person of ordinary skill is expected to employ this configuration as and where appropriate without departing from the original spirit and scope of the present invention.

Although the invention has been explained in relation to its preferred embodiment, it is to be understood that many other possible modifications and variations can be made without departing from the spirit and scope of the invention as hereinafter claimed.

What is claimed is:

1. An automated system of charging an electric vehicle (EV) comprising:
an adapter body;
a contact plate;
a port connector;
at least one guidance beacon;
the contact plate being terminally mounted to the adapter body;
the port connector being terminally mounted to the adapter body, opposite the contact plate;
the at least one guidance beacon being laterally mounted to the adapter body, adjacent to the contact plate; and
the contact plate and the at least one guidance beacon being electrically connected to the port connector.

2. The automated system of charging an EV as claimed in claim 1 comprising:
at least one articulated charging arm;
an elongated contact head;
at least one alignment sensor;
the at least one articulated charging arm comprising a free arm end and a fixed arm end;
the fixed arm end being positioned offset from the adapter body;
the elongated contact head being mounted onto the free arm end;
the at least one alignment sensor being mounted onto the elongated contact head; and
the at least one alignment sensor being oriented towards the contact plate.

3. The automated system of charging an EV as claimed in claim 2 comprising:
the at least one guidance beacon being a plurality of guidance beacons;
the at least one alignment sensor being a plurality of alignment sensors;
the plurality of guidance beacons being radially positioned around the contact plate; and
each of the plurality of alignment sensors being aligned to a corresponding beacon from the plurality of guidance beacons.

4. The automated system of charging an EV as claimed in claim 3 comprising:
the plurality of guidance beacons being a plurality of light emitters;
the plurality of alignment sensors being a plurality of photoreceptors; and
each of the plurality of light emitters being in optical communication with a corresponding photoreceptor from the plurality of photoreceptors.

5. The automated system of charging an EV as claimed in claim 2 comprising:
a lifting actuator;
an arm base;
the fixed arm end being hingedly connected to the arm base; and
the lifting actuator being operatively coupled between the arm base and the at least one articulated charging arm, wherein the lifting actuator is used to selectively offset the free arm end from the arm base.

6. The automated system of charging an EV as claimed in claim 2 comprising:
the elongated contact head being pressed against the contact plate; and
the elongated contact head being electrically connected to the port connector through the contact plate.

7. The automated EV charging apparatus as claimed in claim 1 comprising:
the adapter body comprising a proximal portion, a distal portion, and a ball-and-socket joint;
the proximal portion and the distal portion being pivotably connected to each other by the ball-and-socket joint;
the port connector being integrated into the proximal portion, opposite the ball-and-socket joint; and
the contact plate being integrated into the distal portion, opposite the ball-and-socket joint.

8. The automated EV charging apparatus as claimed in claim 1 comprising:
at least one retention feature; and
the at least one retention feature being laterally mounted to the adapter body, adjacent to the port connector.

9. The automated EV charging apparatus as claimed in claim 1 comprising:
a portable power supply;
the portable power supply being mounted within the adapter body; and
the portable power supply being electrically connected to the contact plate and at least one guidance beacon.

10. The automated EV charging apparatus as claimed in claim 9 comprising:
a charging port;
the charging port being laterally integrated into the adapter body; and
the charging port being electrically connected to the portable power supply.

11. The automated EV charging apparatus as claimed in claim 9 comprising:
the portable power supply being electrically connected to port connector.

12. An automated system of charging an EV comprising:
an adapter body;
a contact plate;
a port connector;
at least one guidance beacon;
at least one articulated charging arm;
an elongated contact head;
at least one alignment sensor;
a lifting actuator;
an arm base;
a portable power supply;
a charging port;
the at least one articulated charging arm comprising a free arm end and a fixed arm end;
the contact plate being terminally mounted to the adapter body;
the port connector being terminally mounted to the adapter body, opposite the contact plate;
the at least one guidance beacon being laterally mounted to the adapter body, adjacent to the contact plate;
the contact plate and the at least one guidance beacon being electrically connected to the port connector;
the fixed arm end being positioned offset from the adapter body;
the elongated contact head being mounted onto the free arm end;
the at least one alignment sensor being mounted onto the elongated contact head;
the at least one alignment sensor being oriented towards the contact plate;
the at least one guidance beacon being a plurality of guidance beacons;
the at least one alignment sensor being a plurality of alignment sensors;
the plurality of guidance beacons being radially positioned around the contact plate;
each of the plurality of alignment sensors being aligned to a corresponding beacon from the plurality of guidance beacons;
the elongated contact head being pressed against the contact plate;
the elongated contact head being electrically connected to the port connector through the contact plate;
the fixed arm end being hingedly connected to the arm base;
the lifting actuator being operatively coupled between the arm base and the at least one articulated charging arm, wherein the lifting actuator is used to selectively offset the free arm end from the arm base;
the portable power supply being mounted within the adapter body;
the portable power supply being electrically connected to the contact plate and at least one guidance beacon;
the charging port being laterally integrated into the adapter body; and
the charging port being electrically connected to the portable power supply.

13. The automated system of charging an EV as claimed in claim 12 comprising:
the plurality of guidance beacons being a plurality of light emitters;
the plurality of alignment sensors being a plurality of photoreceptors; and
each of the plurality of light emitters being in optical communication with a corresponding photoreceptor from the plurality of photoreceptors.

14. The automated EV charging apparatus as claimed in claim 12 comprising:
the adapter body comprising a proximal portion, a distal portion, and a ball-and-socket joint;
the proximal portion and the distal portion being pivotably connected to each other by the ball-and-socket joint;
the port connector being integrated into the proximal portion, opposite the ball-and-socket joint; and
the contact plate being integrated into the distal portion, opposite the ball-and-socket joint.

15. The automated EV charging apparatus as claimed in claim 12 comprising:
at least one retention feature; and
the at least one retention feature being laterally mounted to the adapter body, adjacent to the port connector.

16. The automated EV charging apparatus as claimed in claim 12 comprising:
the portable power supply being electrically connected to port connector.

17. An automated system of charging an EV comprising:
an adapter body;
a contact plate;
a port connector;
at least one guidance beacon;
at least one articulated charging arm;
an elongated contact head;
at least one alignment sensor;
a lifting actuator;
an arm base;
a portable power supply;
a charging port;
the at least one articulated charging arm comprising a free arm end and a fixed arm end;
the contact plate being terminally mounted to the adapter body;
the port connector being terminally mounted to the adapter body, opposite the contact plate;
the at least one guidance beacon being laterally mounted to the adapter body, adjacent to the contact plate;
the contact plate and the at least one guidance beacon being electrically connected to the port connector;
the fixed arm end being positioned offset from the adapter body;
the elongated contact head being mounted onto the free arm end;
the at least one alignment sensor being mounted onto the elongated contact head;
the at least one alignment sensor being oriented towards the contact plate;
the at least one guidance beacon being a plurality of guidance beacons;
the at least one alignment sensor being a plurality of alignment sensors;
the plurality of guidance beacons being radially positioned around the contact plate;
each of the plurality of alignment sensors being aligned to a corresponding beacon from the plurality of guidance beacons;
the elongated contact head being pressed against the contact plate;
the elongated contact head being electrically connected to the port connector through the contact plate;
the fixed arm end being hingedly connected to the arm base;
the lifting actuator being operatively coupled between the arm base and the at least one articulated charging arm, wherein the lifting actuator is used to selectively offset the free arm end from the arm base;
the portable power supply being mounted within the adapter body;
the portable power supply being electrically connected to the contact plate and at least one guidance beacon;
the charging port being laterally integrated into the adapter body;
the charging port being electrically connected to the portable power supply; and
the portable power supply being electrically connected to port connector.

18. The automated system of charging an EV as claimed in claim 17 comprising:
the plurality of guidance beacons being a plurality of light emitters;
the plurality of alignment sensors being a plurality of photoreceptors; and
each of the plurality of light emitters being in optical communication with a corresponding photoreceptor from the plurality of photoreceptors.

19. The automated EV charging apparatus as claimed in claim 17 comprising:
the adapter body comprising a proximal portion, a distal portion, and a ball-and-socket joint;
the proximal portion and the distal portion being pivotably connected to each other by the ball-and-socket joint;
the port connector being integrated into the proximal portion, opposite the ball-and-socket joint; and
the contact plate being integrated into the distal portion, opposite the ball-and-socket joint.

20. The automated EV charging apparatus as claimed in claim 17 comprising:
at least one retention feature; and
the at least one retention feature being laterally mounted to the adapter body, adjacent to the port connector.
